(19) United States
(12) Patent Application Publication
(10) Pub. No.: US 2015/0159246 A1
(43) Pub. Date: Jun. 11, 2015

(54) BASE MATERIAL FOR HIGH-TOUGHNESS CLAD STEEL PLATE AND METHOD OF PRODUCING THE CLAD STEEL PLATE

(71) Applicant: JFE Steel Corporation, Tokyo (JP)

(72) Inventors: Keiichiro Kishi, Fukuyama (JP); Yoshihiro Yazawa, Chiba (JP); Shunichi Tachibana, Fukuyama (JP); Yota Kuronuma, Fukuyama (JP); Toshiyuki Hoshino, Tokyo (JP); Kimihiro Nishimura, Tokyo (JP)

(21) Appl. No.: 14/402,133

(22) PCT Filed: May 22, 2013
(86) PCT No.: PCT/JP2013/003270

§ 371 Date: Nov. 19, 2014

(30) Foreign Application Priority Data
May 23, 2012 (JP) 2012-117486
Mar. 29, 2013 (JP) 2013-071282

(51) Int. Cl. C22C 38/58; C21D 9/46; B23K 20/04; C22C 38/50; C22C 38/48; C22C 38/46; C22C 38/44; C22C 38/42; C22C 38/14; C22C 38/12; C22C 38/06; C22C 38/04; C22C 38/02; C22C 38/00; C21D 8/02

(52) U.S. Cl. CPC C22C 38/58; C21D 8/0247; C21D 8/0278; C21D 9/46; B23K 20/04; C22C 38/50; C22C 38/48; C22C 38/46; C22C 38/44; C22C 38/42; C22C 38/14; C22C 38/12; C22C 38/06; C22C 38/04; C22C 38/02; C22C 38/002; C22C 38/001

(57) ABSTRACT

A base metal for a high-toughness clad plate has a shear area of 85% or more in a −20° C. DWTT test and includes, in terms of % by mass, C: 0.030% to 0.10%, Si: 0.10% to 0.30%, Mn: 1.30% to 1.80%, P: 0.015% or less, S: 0.003% or less, Mo: 0.05% to 0.50%, V: less than 0.010%, Nb: 0.010% to 0.060%, Ti: 0.005% to 0.020%, Al: 0.040% or less, Ca: 0.0010% to 0.0040%, N: 0.0030% to 0.0060%, and the balance being Fe and unavoidable impurities.

### TECHNICAL FIELD

This disclosure relates to a base metal for a high-toughness clad plate and a method of manufacturing the clad plate.

### BACKGROUND

In recent years, because of energy issues, energy resource development has been pursued even in regions called “difficult-to-mine-environments” where mining has been considered impossible. Such environments are particularly highly corrosive and require application of high-alloy clad steels that have higher corrosion resistance. Moreover, in a difficult-to-mine environment, industrial facilities and structures are required to achieve durability and long life, and be maintenance-free. Accordingly, Ni-based alloys or Ni alloys such as those represented by Alloy 625 and 825 are attracting much attention as the materials that satisfy such requirements.

The price of the main raw material of Ni alloys, i.e., Ni, and the alloy elements such as Mo and Cr may rise steeply or undergo significant fluctuation from time to time. Accordingly, clad steels that can more economically achieve high anticorrosion performance of high alloy than when solid metals (when the metal composition of the cladding material is achieved throughout the entire thickness) are used have drawn much attention recently.

A high-alloy clad steel is a steel material constituted of bonding two types of metals having different properties, i.e., a Ni-based alloy as a cladding material and a low-alloy steel as a base metal. A clad steel is prepared by metallurgically joining different types of metals. Unlike plated materials, clad steels do not undergo separation and can exhibit various novel properties that cannot be achieved by single metals and alloys.

Clad steels can have functions comparable to those of solid metals if cladding materials that have functions suited for the purpose of each operating environment are selected. Moreover, carbon steels and low-alloy steels suited for use in severe environments because of their high toughness and high strength other than corrosion resistance can be used as the base metal of clad steels.

Since clad steels use fewer alloy elements than solid metals and can reliably exhibit corrosion resistance comparable to that of solid metals while ensuring strength and toughness comparable to those of carbon steels and low-alloy steels, both economical efficiency and functionality can be achieved.

Accordingly, clad steels that use high-alloy cladding materials are considered to be very useful functional steel materials and the need therefor has increased in various industrial fields in recent years.

Clad steels have different usages depending on the cladding materials and manufacturing methods therefor are also different. As the base metal of clad plates, low-carbon low-alloy steels to which minute amounts of alloy components such as Nb and V or Ti and B are added are sometimes used. Such low-carbon low-alloy steels are manufactured by particular quenching tempering (hereinafter also referred to as “thermal refining”) or through controlled rolling during hot rolling (thermo mechanical control process (TMCP)).

In manufacturing clad steel pipes by forming clad steels, steel plates are formed into pipe shapes and one pass of high efficiency welding is performed on each of the two surfaces of the pipes.

In general, in multilayer welding, the boundary between a weld metal and a steel plate to be welded (this is called “base metal” as a welding term, in case the steel plate needs to be distinguished from the base metal of a clad plate, it is referred to as “steel plate to be welded” or “base metal (B.M.)” hereinafter) and a heat affected zone (HAZ) of the base metal (B.M.) undergo grain refining by the influence of the heat from the next pass. However, in single-pass welding, the crystal grains at the boundary between the base metal (B.M.) and the weld metal (hereinafter referred to as “weld bonded zone”) and in the HAZ are coarse, resulting in low toughness.

For example, when operation of pipelines is stopped for an emergency, various parts of pipes are put in a low-temperature environment at −40° C. Thus, the Charpy impact absorption energy at −40° C. (vE-40° C.) of the base metals (B.M.) and HAZ is beginning to be specified 35 (J) or more. Moreover, base metals (B.M.) are also required to be specified 85% or higher shear area in a drop weight tear test (DWTT) at −20° C. (85% shear area transition temperature (SATT)) conducted to confirm the brittle fracture arrest temperature. Accordingly, various methods of improving the toughness have been publicized. In the methods disclosed in Japanese Unexamined Patent Application Publication No. 2004-149821 and Japanese Unexamined Patent Application Publication No. 2006-328460, the toughness at the welded joint has been improved by optimizing the amounts of Ti and N added.

Japan Steel Works Technical Review No. 55 (2004), pp. 77-78 discloses an example of production based on JP '821 and JP '460. Japanese Examined Patent Application Publication No. 55-26164 discloses a technique of improving toughness by adding Ti, N, Nb, V, and B to C, Si, Mn, and Al to precipitate fine TiN in the steel and to decrease the size of the austenite grains in a HAZ.

According to the methods disclosed in JP '821 and JP '460, a pinning effect of suppressing coarsening of the microstructure in a zone heated to high temperature is observed when generated TiN remain undissolved. However, TiN remains coarse and little pinning effect is observed by heating employed in typical processes of manufacturing clad steels and thus coarsening of microstructures in such zones has not been sufficiently suppressed.

Japan Steel Works Technical Review No. 55 (2004), pp. 77-78 makes no mention of the zones where the pinning effect of TiN is not sufficiently observed.

The method disclosed in JP '164 requires an additional step of re-heating the plate to a temperature of 1150° C. or lower. This poses a problem for industrial implementation since the production cost is increased.

It could therefore be helpful to provide a base metal for a high-toughness clad plate to which multiple alloy elements are added to address the problems described above and method of manufacturing the clad plate.

### SUMMARY

We found that improvements in toughness are not solely achieved by TiN in a base metal of a clad plate and discovered that the toughness of the base metal of a clad plate can be improved by clarifying the behavior of the precipitates.

To be more specific, we found that vanadium (V), the addition of which has been considered essential to adjust the strength in the related art, dissolves in steel at about 900° C. and excessively increases the quenching property, thereby degrading the HAZ toughness due to hardening. Thus, in designing the composition of the base metal of the clad steel, we decided not to add V. Moreover, to suppress the decrease in toughness of the base metal of a clad steel heated to a temperature range of about 1000° C., the precipitation amount and morphology of TiN and NbC is controlled to suppress coarsening of the y grain diameter during heating.

We found that in this manner, a base metal of a clad plate having excellent low-temperature toughness can be obtained. The base metal is preferably 50 mm or less in thickness. Thus, it is possible to provide a base metal for a high-toughness clad plate in which the low-temperature toughness of the base metal is ensured by addition of multiple alloy elements and refining.

We thus provide:
[1] A base metal for a high-toughness clad plate, the base metal having a shear area of 85% or more in a −20° C. DWTT test and including, in terms of % by mass, C: 0.030% to 0.10%, Si: 0.10% to 0.30%, Mn: 1.30% to 1.80%, P: 0.015% or less, S: 0.003% or less, Mo: 0.05% to 0.50%, V: less than 0.010%, Nb: 0.010% to 0.060%, Ti: 0.005% to 0.020%, Al: 0.040% or less, Ca: 0.0010% to 0.0040%, N: 0.0030% to 0.0060%, and the balance being Fe and unavoidable impurities.
[2] The base metal for a high-toughness clad plate according to [1], further including, in terms of % by mass, at least one selected from Ni: 0.10% to 0.50%, Cr: 0.01% to 0.50%, and Cu: 0.005% to 0.050%.
[3] The base metal for a high-toughness clad plate according to [1] or [2], wherein the ratio of the Ti content to the N content, Ti/N, in terms of % by mass is in the range of 2.0 to 3.5.
[4] The base metal for a high-toughness clad plate according to any one of [1] to [3], wherein the ratio of the Nb content to the C content, Nb/C, in terms of % by mass is in the range of 0.2 to 2.0.
[5] A clad plate having the base metal according to any one of [1] to [4].
[6] A method of manufacturing a high-toughness base metal for clad plate having a shear area of 85% or more in a −20° C. DWTT test, the method including clad-rolling the base metal according to any one of [1] to [4] and a cladding material, performing heating to 900° C. to 1100° C. to conduct a solution treatment, and performing a tempering treatment at a temperature less than 550° C.

The content of V which causes deterioration of the HAZ toughness is reduced as much as possible and appropriate amounts of Nb, Al, Ti, N, and the like are added to make crystal grains of a base metal of a clad steel to be ultrafine. Thus, coarsening of crystal grain size can be suppressed and excellent low-temperature toughness can be achieved in a base metal and a heat-affected zone generated in single-pass welding.

### DETAILED DESCRIPTION

The reasons for limitations for selected features will now be described.

### 1. Composition

First, the reasons for limiting the composition of a steel are described. Note that % indicating the content of each element means % by mass unless otherwise noted.

### C: 0.030% to 0.10%

Carbon (C) is a component effective in improving the strength of steels. The C content is 0.030% or more since strength required for steel materials for general welding cannot be obtained at a C content less than 0.030%. In contrast, at a C content exceeding 0.10%, weldability of the steel material and HAZ toughness are significantly degraded. Accordingly, the C content is limited to 0.030% to 0.10% and is preferably 0.04% to 0.08%.

### Si: 0.10% to 0.30%

Silicon (Si) is a component needed to ensure strength of the base metal and for deoxidation. To achieve such effects, the Si content needs to be at least 0.10%. At a Si content exceeding 0.30%, the HAZ hardens and the toughness is decreased. Accordingly, the Si content is limited to 0.10% to 0.30%. From the viewpoint of the HAZ toughness, the Si content is preferably 0.13% to 0.20%.

### Mn: 1.30% to 1.80%

Manganese (Mn) is a component effective in ensuring the strength and toughness of the base metal and a Mn content of 1.30% or more is needed. Considering the toughness and cracking of the welded zones, the upper limit is 1.80%. Thus, the Mn content is limited to 1.30% to 1.80%. From the viewpoints of toughness of the base metal and the HAZ toughness, the Mn content is preferably 1.40% to 1.55%.

P: 0.015% or less

The P content is preferably as low as possible. However, since it is costly to remove P, the P content is limited to 0.015% or less.

S: 0.003% or less

The S content is preferably as low as possible. Since excessive S significantly decreases toughness, the S content is limited to 0.003% or less.

### Mo: 0.05% to 0.50%

Molybdenum (Mo) is an element that stably improves the strength and toughness of the base metal after a solution heat-treatment. Since such an effect is not obtained at a Mo content less than 0.05%, the Mo content is 0.05% or more. At a Mo content exceeding 0.50%, the toughness of the HAZ is degraded. Thus, the Mo content is limited to 0.05% to 0.50%. From the viewpoints of the strength and HAZ toughness of the base metal, the Mo content is preferably 0.08% to 0.20%.

V: less than 0.010%

Vanadium (V) is an element that should draw most attention. The V content needs to be as low as possible. Conventionally, V has been intentionally added to achieve precipitation strengthening caused by fine precipitates such as VC and VN. However, when a step of quenching by conducting heating at 900° C. or higher is included in the process of manufacturing the clad steel, fine precipitates such as VC and VN become dissociated and dissolved in steel upon heating. This phenomenon occurs because these fine precipitates dissolve when heated to 900° C. or higher in our C content range. Accordingly, the V added tends not to remain as fine precipitates but becomes dissociated during heating, acts as a quenching element, and causes significant hardening in both the base metal and HAZ, thereby deteriorating toughness. Deterioration of toughness becomes notable when the V content is 0.010% or more. Thus, the V content is limited to less than 0.010%. More preferably, the V content is less than 0.004% and most preferably zero on an industrially applicable level.

### Nb: 0.010% to 0.060%

Niobium (Nb) forms NbC, prevents coarsening of austenite grains during heating the steel to a temperature of the solution treatment, and makes grains finer. Niobium carbides and the like are finely and evenly dispersed in the base metal and thus the high-temperature strength and other associated properties are enhanced. Such effects are observed at a Nb content of 0.010% or more. However, at a Nb content higher than 0.060%, not only these effects are no longer achieved, but also surface defects readily occur on the steel ingot. Accordingly, the Nb content is limited to 0.010% to 0.060%. The Nb content is preferably 0.025% to 0.05% for the same reason.

### Ti: 0.005% to 0.020%

Titanium (Ti) bonds to N as with Nb, suppresses coarsening of crystal grains, makes the microstructure finer after the solution treatment, and improves the toughness. Since these effects are little at a Ti content less than 0.005%, the Ti content is at least 0.005%. At a Ti content exceeding 0.020%, the toughness of the weld heat affected zone is significantly degraded due to a notch effect. Accordingly, the Ti content is limited to 0.005% to 0.020% and is preferably 0.010% to 0.016%.

Al: 0.040% or less

Aluminum (Al) is an element effective as a deoxidizer. During the solution treatment, AlN prevents coarsening of the austenite crystal grains. However, at an Al content exceeding 0.040%, the effect of making grains finer is deteriorated and the toughness is degraded. At an Al content exceeding 0.040%, AlN is excessively generated and may cause surface defects of the steel ingots. Accordingly, the Al content is limited to 0.040% or less. For the same reason, the Al content is preferably 0.035% or less.

### Ca: 0.0010% to 0.0040%

Calcium (Ca) controls the morphology of sulfide-based inclusions, improves toughness of the weld heat affected zones, and is effective in controlling the morphology of MnS, thereby improving the impact value. Moreover, Ca improves resistance to hydrogen-induced cracking. The Ca content at which such effects are exhibited is 0.0010% or more. However, at a Ca content exceeding 0.0040%, the effects are saturated, cleanliness is decreased, toughness of the weld heat affected zone is deteriorated, and resistance to hydrogen-induced cracking is deteriorated. Moreover, surface defects tend to occur on steel ingots. Accordingly, the Ca content is limited to 0.0010% to 0.0040%. The Ca content is preferably 0.0020% to 0.0030%.

### N: 0.0030% to 0.0060%

Nitrogen (N) precipitates by forming TiN and has an effect of improving the HAZ toughness. At a N content less than 0.0030%, the effect is low. Thus, the lower limit is 0.0030%. At a N content exceeding 0.0060%, the amount of solid solution N increases and HAZ toughness decreases. Considering the improvement of the HAZ toughness by fine precipitates of TiN corresponding to the amount of Ti added, the N content is limited to 0.0030% to 0.0060%. Preferably, the N content is 0.0030% to 0.0040%.

The above-described elements are basic elements. In addition to these elements, at least one selected from Ni, Cr, and Cu may be optionally contained as described below.

### Ni: 0.10% to 0.50%

Nickel (Ni) is effective in improving the strength and toughness of the base metal and 0.10% or more of Ni is preferably contained. However, at a Ni content exceeding 0.50%, the effect is saturated and production cost is increased. Accordingly, when Ni is to be added, the Ni content is preferably 0.10% to 0.50% and more preferably 0.20% to 0.40%.

### Cr: 0.01% to 0.50%

Chromium (Cr) is effective in improving strength and toughness of the base metal and 0.01% or more of Cr is preferably contained. However, at Cr content exceeding 0.50%, HAZ toughness may be decreased. Accordingly, when Cr is to be added, the Cr content is preferably 0.01% to 0.50% and more preferably 0.01% to 0.30%.

### Cu: 0.005% to 0.050%

Copper (Cu) is effective in improving toughness and increasing strength and 0.005% or more of Cu is preferably contained. However, excessively adding Cu may degrade the resistance to cracking during welding. Accordingly, when Cu is to be added, the Cu content is preferably 0.005% to 0.050% and more preferably 0.01% to 0.025%.

### Ti/N: 2.0 to 3.5

Titanium (Ti) and nitrogen (N) that form TiN are, as discussed above, important elements for improving the toughness of HAZ. To sufficiently exhibit such an effect, the relationship between the Ti content and the N content is also important. That is, the crystal grains become coarse and the toughness may significantly decrease at Ti/N of less than 2.0 on a percent by mass basis. At a Ti/N exceeding 3.5, the toughness may decrease for the same reason. Accordingly, Ti/N is preferably 2.0 to 3.5 and more preferably 2.5 to 3.5.

### Nb/C: 0.2 to 2.0

Niobium (Nb) and carbon (C) form NbC and have an effect of making crystal grains finer. During the quenching tempering treatment, Nb and C contribute to improving the toughness. However, such an effect is observed at Nb/C of 0.2 or more and no longer observed at Nb/C exceeding 2.0. Accordingly, Nb/C is preferably 0.2 to 2.0 and more preferably 0.3 to 1.8.

### 2. Toughness

### DWTT Test: Percent Ductile Fracture of 85% or More at −20° C.

Line pipes preferably have a high shear area (SA(%)) in DWTT test prescribed in API-5L from the viewpoint of preventing brittle fracture. Accordingly, the shear area at −20° C. is limited to 85% or more (85% SATT). In this manner, the safety can be enhanced and an industrial advantage is provided.

### 3. Manufacturing Method

The base metal raw material of the clad steel is adjusted to the composition ranges described above and can be prepared by a common method or the like. The raw material of the cladding material is selected according to the usage and the base metal raw material is clad-rolled into a clad plate.

For use in pipelines of natural gas and the like, high alloys such as Alloy 625 and 825 can be used as the cladding material, for example. Note that the thickness of the base metal raw mater-ial of the clad steel is preferably 50 mm or less. When the thickness of the base metal raw mater-ial is 25 mm or more, the cladding material and the base metal raw material are superposed on each other and rolled as one pair. When the thickness of the base metal raw material is less than 25 mm, two pairs can be superposed onto each other and rolled. The conditions for clad rolling are not particularly limited and common methods may be employed.

A clad plate obtained as above is heated to a temperature of 900° C. to 1100° C. for a solution treatment. When the solution treatment is conducted at less than 900° C., the base metal does not reliably achieve sufficient strength. When exceeding 1100° C., the toughness of the base metal is deteriorated. Accordingly, heating is conducted at 900° C. to 1100° C. for the solution treatment, and more preferably 900° C. to 980° C. The time taken for the solution treatment is preferably 10 to 30 minutes although this depends on the thickness of the clad plate. However, holding a high temperature for a long time may generate precipitates in the cladding material depending on the type of the cladding material and thus the time may be shorter than 10 minutes. After the solution treatment, the plate is cooled with water, oil, or the like (at a cooling rate of 2° C./min or more, for example).

Then a tempering treatment is conducted by heating the plate at a temperature lower than 550° C. Since the DWTT properties are deteriorated at 550° C. or higher, the temperature is limited to lower than 550° C. The tempering treatment temperature is preferably 420° C. to 500° C. The tempering heating time is, for example, 5 to 35 minutes. The microstructure of the base metal of the clad plate can be refined by the series of the thermal refining treatment described above.

The clad plate can be used as is or formed into steel pipes and used as clad steel pipes. During welding, the clad plate can be welded by performing one pass of welding on each surface. Despite single pass welding, the HAZ maintains a fine microstructure and excellent toughness can be ensured.

### EXAMPLES

Examples will now be compared with comparative examples and described.

The toughness of the base metal was evaluated by taking a DWTT specimen in accordance with API-5L and subjecting the specimen to DWTT test (drop weight properties) at −20° C. Specimens exhibiting a shear area of 85% or more in the DWTT test at −20° C. were rated as having excellent toughness as a base metal. The required strength was assumed to be a tensile strength of 590 MPa or higher.

Clad plates were manufactured by using the base metals having chemical compositions shown in Table 1 and Alloy 625. For the manufacturing conditions, a base metal and a cladding material were superposed on each other to form a pair and the pair was heated in a heating furnace to 1150° C. and hot-rolled to form a clad plate constituted of a base metal with a thickness of 30 mm and a cladding material with a thickness of 3 mm. After completion of rolling, the plate was heated to 910° C. to perform a solution treatment and then heated to 500° C. to conduct a tempering treatment. A clad plate prepared by the same manner, but with a tempering temperature of 600° C. was manufactured as a comparative example.

A clad plate after a series of heat treatments was cold-formed into a clad steel pipe having an outer diameter of 500 mm and the properties of the base metal were investigated. The results are shown in Table 2.

In Table 2, in Examples Nos. 1 to 12 made from base metals having a chemical composition that satisfies our range, the DWTT properties of the base metal satisfy the target properties. In contrast, the DWTT properties of the base metal and the tensile strength did not satisfy the target values in Comparative Examples No. 13 and 17 with a V content outside our range, Comparative Examples 14 and 18 with a Mn content outside our range, Comparative Examples 15, 19, and 20 with Ti/N outside our range, and Comparative Examples 16 and 21 with Nb/C outside our range. In Comparative Examples 22 and 23, the tempering temperature was as high as 600° C. and thus the DWTT properties of the base metal did not satisfy the target value.

TABLE 1

| | Steel | Chemical composition (unit: % by mass) | | | | | | | | |
|---|---|---|---|---|---|---|---|---|---|---|
| No. | No. | C | Si | Mn | P | S | Ni | Cr | Cu | Mo |
| 1 | A1 | 0.078 | 0.30 | 1.70 | 0.010 | 0.0010 | - | - | - | 0.20 |
| 2 | A2 | 0.077 | 0.30 | 1.75 | 0.010 | 0.0010 | - | - | - | 0.20 |
| 3 | A3 | 0.055 | 0.30 | 1.65 | 0.010 | 0.0010 | 0.30 | 0.25 | 0.30 | 0.20 |
| 4 | A4 | 0.060 | 0.30 | 1.58 | 0.010 | 0.0010 | 0.30 | 0.25 | 0.30 | 0.20 |
| 5 | A5 | 0.061 | 0.30 | 1.49 | 0.010 | 0.0010 | 0.30 | 0.25 | 0.30 | 0.20 |
| 6 | A6 | 0.062 | 0.30 | 1.35 | 0.010 | 0.0010 | 0.30 | 0.25 | 0.30 | 0.20 |
| 7 | A7 | 0.062 | 0.30 | 1.55 | 0.010 | 0.0010 | 0.01 | 0.25 | 0.01 | 0.20 |
| 8 | A8 | 0.068 | 0.30 | 1.55 | 0.010 | 0.0010 | 0.30 | 0.01 | 0.30 | 0.20 |
| 9 | A9 | 0.083 | 0.30 | 1.55 | 0.010 | 0.0010 | 0.01 | 0.05 | 0.01 | 0.20 |
| 10 | A10 | 0.066 | 0.30 | 1.55 | 0.010 | 0.0010 | 0.01 | 0.25 | 0.01 | 0.20 |
| 11 | A11 | 0.062 | 0.30 | 1.55 | 0.010 | 0.0010 | 0.01 | 0.25 | 0.01 | 0.20 |
| 12 | A12 | 0.061 | 0.30 | 1.55 | 0.010 | 0.0010 | 0.01 | 0.25 | 0.01 | 0.20 |
| 13 | B1 | 0.065 | 0.30 | 1.27 | 0.010 | 0.0010 | - | - | - | 0.20 |
| 14 | B2 | 0.065 | 0.30 | 1.00 | 0.010 | 0.0010 | - | - | - | 0.20 |
| 15 | B3 | 0.079 | 0.30 | 1.74 | 0.010 | 0.0010 | - | - | - | 0.20 |
| 16 | B4 | 0.071 | 0.30 | 1.72 | 0.010 | 0.0010 | - | - | - | 0.20 |
| 17 | B5 | 0.065 | 0.30 | 1.27 | 0.010 | 0.0010 | 0.30 | 0.25 | 0.30 | 0.20 |
| 18 | B6 | 0.065 | 0.30 | 0.99 | 0.010 | 0.0010 | 0.30 | 0.25 | 0.30 | 0.20 |
| 19 | B7 | 0.065 | 0.30 | 1.55 | 0.010 | 0.0010 | 0.01 | 0.25 | 0.01 | 0.20 |
| 20 | B8 | 0.065 | 0.30 | 1.55 | 0.010 | 0.0010 | 0.01 | 0.25 | 0.01 | 0.20 |
| 21 | B9 | 0.065 | 0.30 | 1.55 | 0.010 | 0.0010 | 0.01 | 0.25 | 0.01 | 0.20 |
| | | Chemical composition (unit: % by mass) | | | | | | Ti/N | Nb/C | |
| | No. | V | Al | Nb | Ti | N | Ca | *1 | *1 | Reference |
| | 1 | 0.004 | 0.030 | 0.030 | 0.010 | 0.0040 | 0.0020 | 2.50 | 0.38 | Example |
| | 2 | 0.005 | 0.030 | 0.030 | 0.010 | 0.0040 | 0.0020 | 2.50 | 0.39 | Example |
| | 3 | 0.004 | 0.030 | 0.030 | 0.010 | 0.0040 | 0.0020 | 2.50 | 0.55 | Example |
| | 4 | 0.005 | 0.030 | 0.030 | 0.010 | 0.0040 | 0.0020 | 2.50 | 0.50 | Example |
| | 5 | 0.009 | 0.030 | 0.030 | 0.010 | 0.0040 | 0.0020 | 2.50 | 0.49 | Example |
| | 6 | 0.007 | 0.015 | 0.030 | 0.010 | 0.0040 | 0.0020 | 2.50 | 0.48 | Example |
| | 7 | 0.005 | 0.030 | 0.030 | 0.010 | 0.0040 | 0.0020 | 2.50 | 0.48 | Example |
| | 8 | 0.005 | 0.030 | 0.030 | 0.010 | 0.0040 | 0.0020 | 2.50 | 0.44 | Example |
| | 9 | 0.005 | 0.030 | 0.030 | 0.010 | 0.0040 | 0.0020 | 2.50 | 0.36 | Example |
| | 10 | 0.005 | 0.030 | 0.030 | 0.015 | 0.0045 | 0.0020 | 3.33 | 0.45 | Example |
| | 11 | 0.005 | 0.030 | 0.030 | 0.009 | 0.0040 | 0.0020 | 2.25 | 0.48 | Example |
| | 12 | 0.005 | 0.030 | 0.030 | 0.010 | 0.0030 | 0.0020 | 3.33 | 0.49 | Example |
| | 13 | 0.065 | 0.030 | 0.030 | 0.010 | 0.0040 | 0.0020 | 2.50 | 0.46 | Comparative |
| | | | | | | | | | | Example |
| | 14 | 0.006 | 0.030 | 0.030 | 0.010 | 0.0040 | 0.0020 | 2.50 | 0.46 | Comparative |
| | | | | | | | | | | Example |
| | 15 | 0.005 | 0.030 | 0.030 | 0.016 | 0.0040 | 0.0020 | 4.00 | 0.38 | Comparative |
| | | | | | | | | | | Example |
| | 16 | 0.005 | 0.030 | 0.010 | 0.010 | 0.0040 | 0.0020 | 2.50 | 0.14 | Comparative |
| | | | | | | | | | | Example |
| | 17 | 0.050 | 0.030 | 0.030 | 0.010 | 0.0040 | 0.0020 | 2.50 | 0.46 | Comparative |
| | | | | | | | | | | Example |
| | 18 | 0.006 | 0.030 | 0.030 | 0.010 | 0.0040 | 0.0020 | 2.50 | 0.46 | Comparative |
| | | | | | | | | | | Example |
| | 19 | 0.005 | 0.030 | 0.030 | 0.018 | 0.0040 | 0.0020 | 4.50 | 0.46 | Comparative |
| | | | | | | | | | | Example |
| | 20 | 0.005 | 0.030 | 0.030 | 0.008 | 0.0052 | 0.0020 | 1.54 | 0.46 | Comparative |
| | | | | | | | | | | Example |
| | 21 | 0.005 | 0.030 | 0.010 | 0.010 | 0.0040 | 0.0020 | 2.50 | 0.15 | Comparative |
| | | | | | | | | | | Example |

Note:
Underlined values are outside our scope. Hyphens (-) each indicate that the corresponding element was not added.
*1: Ratio on a percent by mass basis.

TABLE 2

| | | | | | | Drop weight | |
|---|---|---|---|---|---|---|---|
| | | Tempering | Tensile property of base metal | | | properties of | |
| | Steel | temperature | YS | TS | El | base metal DWTT | |
| No. | No. | (° C.) | (Mpa) | (Mpa) | (%) | −20° C. SA % | Reference |
| 1 | A1 | 500 | 501 | 601 | 28.5 | 100 | Example |
| 2 | A2 | 500 | 510 | 605 | 27.5 | 100 | Example |
| 3 | A3 | 500 | 540 | 655 | 27.0 | 100 | Example |
| 4 | A4 | 500 | 538 | 644 | 27.6 | 95 | Example |
| 5 | A5 | 500 | 524 | 635 | 28.9 | 95 | Example |
| 6 | A6 | 500 | 503 | 609 | 29.4 | 100 | Example |
| 7 | A7 | 500 | 501 | 607 | 26.7 | 92 | Example |
| 8 | A8 | 500 | 499 | 602 | 29.5 | 90 | Example |
| 9 | A9 | 500 | 498 | 595 | 31.0 | 85 | Example |
| 10 | A10 | 500 | 501 | 608 | 29.7 | 95 | Example |
| 11 | A11 | 500 | 499 | 605 | 28.4 | 94 | Example |
| 12 | A12 | 500 | 501 | 604 | 29.4 | 95 | Example |
| 13 | B1 | 500 | 504 | 599 | 30.5 | 80 | Comparative |
| | | | | | | | Example |
| 14 | B2 | 500 | 381 | 477 | 36.1 | 80 | Comparative |
| | | | | | | | Example |
| 15 | B3 | 500 | 506 | 605 | 28.0 | 75 | Comparative |
| | | | | | | | Example |
| 16 | B4 | 500 | 502 | 600 | 27.9 | 75 | Comparative |
| | | | | | | | Example |
| 17 | B5 | 500 | 500 | 606 | 29.1 | 80 | Comparative |
| | | | | | | | Example |
| 18 | B6 | 500 | 445 | 540 | 31.7 | 80 | Comparative |
| | | | | | | | Example |
| 19 | B7 | 500 | 501 | 608 | 28.1 | 75 | Comparative |
| | | | | | | | Example |
| 20 | B8 | 500 | 512 | 613 | 28.9 | 80 | Comparative |
| | | | | | | | Example |
| 21 | B9 | 500 | 518 | 608 | 29.2 | 75 | Comparative |
| | | | | | | | Example |
| 22 | A1 | 600 | 499 | 603 | 28.0 | 80 | Comparative |
| | | | | | | | Example |
| 23 | A3 | 600 | 515 | 610 | 27.5 | 75 | Comparative |
| | | | | | | | Example |

Note:
Underlined values are outside our scope.

1-6. (canceled)

7. A base metal for a high-toughness clad plate, the base metal having a shear area of 85% or more in a −20° C. DWTT test and comprising, in terms of % by mass, C: 0.030% to 0.10%, Si: 0.10% to 0.30%, Mn: 1.30% to 1.80%, P: 0.015% or less, S: 0.003% or less, Mo: 0.05% to 0.50%, V: less than 0.010%, Nb: 0.010% to 0.060%, Ti: 0.005% to 0.020%, Al: 0.040% or less, Ca: 0.0010% to 0.0040%, N: 0.0030% to 0.0060%, and the balance being Fe and unavoidable impurities.

8. The base metal according to claim 7, further comprising, in terms of % by mass, at least one selected from Ni: 0.10% to 0.50%, Cr: 0.01% to 0.50%, and Cu: 0.005% to 0.050%.

9. The base metal according to claim 7, wherein a ratio of Ti content to N content, Ti/N, in terms of % by mass is 2.0 to 3.5.

10. The base metal according to claim 7, wherein a ratio of Nb content to C content, Nb/C, in terms of % by mass is 0.2 to 2.0.

11. A clad plate having the base metal according to claim 7.

12. A method of manufacturing a high-toughness base metal for a clad plate having a shear area of 85% or more in a −20° C. DWTT test, comprising clad-rolling the base metal according to claim 7 and a cladding material, performing heating to 900° C. to 1100° C. to conduct a solution treatment, and performing a tempering treatment at a temperature less than 550° C.

13. The base metal according to claim 8, wherein a ratio of Ti content to N content, Ti/N, in terms of % by mass is 2.0 to 3.5.

14. The base metal according to claim 8, wherein a ratio of Nb content to C content, Nb/C, in terms of % by mass is 0.2 to 2.0.

15. The base metal according to claim 9, wherein a ratio of Nb content to C content, Nb/C, in terms of % by mass is 0.2 to 2.0.

16. A clad plate having the base metal according to claim 8.

17. A clad plate having the base metal according to claim 9.

18. A clad plate having the base metal according to claim 10.

19. A method of manufacturing a high-toughness base metal for a clad plate having a shear area of 85% or more in a −20° C. DWTT test, comprising clad-rolling the base metal according to claim 8 and a cladding material, performing heating to 900° C. to 1100° C. to conduct a solution treatment, and performing a tempering treatment at a temperature less than 550° C.

20. A method of manufacturing a high-toughness base metal for a clad plate having a shear area of 85% or more in a −20° C. DWTT test, comprising clad-rolling the base metal according to claim 9 and a cladding material, performing heating to 900° C. to 1100° C. to conduct a solution treatment, and performing a tempering treatment at a temperature less than 550° C.

21. A method of manufacturing a high-toughness base metal for a clad plate having a shear area of 85% or more in a −20° C. DWTT test, comprising clad-rolling the base metal according to claim 10 and a cladding material, performing heating to 900° C. to 1100° C. to conduct a solution treatment, and performing a tempering treatment at a temperature less than 550° C.
